(19) United States
(12) Patent Application Publication
(10) Pub. No.: US 2007/0299675 A1
(43) Pub. Date: Dec. 27, 2007

(54) TROPHY SURE

(76) Inventor: Steven Pecora, Bohemia, NY (US)

Correspondence Address: LILLIE LAW, LLC, 269 SOUTHPORT ST, RONKONKOMA, NY, 11779, US

(21) Appl. No.: 11/379,331

(22) Filed: Jun. 22, 2006

(51) Int. Cl. G06Q 10/00; G06Q 30/00

(52) U.S. Cl. 705/1

(57) ABSTRACT

A hunting system comprising sighting means for aiming said system at a desired target and collecting input data regarding said desired target, said means being cooperatively connected to database means for storing profiles, processing means for determining the nearest match between profiles, and indicating means for displaying the determined criteria.

### BACKGROUND OF THE INVENTION

This invention relates to a hunting device and system, particularly, a hunting device and system which maximizes the likelihood of accurately identifying a target's specifications prior to deployment of ammunition.

Historically, hunters have embarked on excursions around the globe in the search of game for a plethora of reasons. Initially, man as a species undertook the act of hunting for food, however, more contemporarily, man has amended such basis and sought to engage in the act of hunting for sport. Moreover, modern man has also recognized the related rates between the number of hunters, the frequency, and duration of their excursions, on the number of and types of game available, as such, the respective government entities have instituted controls, such as quotas, and protection such as classifying types of game on lists, inter alia, such as endangered species. Furthermore, such protections as defining the minimum size a type of game may be is quite common.

A hunter has several methods available to assist in estimating a prospective prey. A hunter in the process of tracking a bear, may for example, estimate the size of the bear based on its footprint. Particularly, it has been statistically determined that the length of a bear's pad is indicative of the weight of the bear. The following is a table that a hunter may use when tracking a bear.

| Length of Pad (inches) | Estimated Weight (lbs) |
|---|---|
| 4 | Less than 100 |
| 5 | 100 to 125 |
| 6 | 125 to 200 |
| 7 | 200 to 300 |
| 8 | 300 to 400 |
| 9+ | 400 to 500 |

Other methods include placing a fixed object in the particular area where the hunter takes a position, such as 55 gallon barrel. The barrel may be stood on end or positioned on its side, wherein each orientation indicates a different reference for the hunter to use when the bear approaches the fixed object, but again, this method leaves room for operator error and is a crude estimate prior to taking the animal.

At this juncture, the only reliable method of calculating the score of an animal is post mortem. FIG. 1 exhibits the accepted method of scoring a bear trophy by the New York State Big Buck Club (NYS-big-buck.org), the Pope & Young Club, and the Boone & Crockett Club (boone-crockett.org), although each organization may vary regarding the acceptable minimum based on method of taking the animal, however, the methods of calculating appear constant. Measurements are taken with calipers or by using parallel perpendiculars, to the nearest sixteenth of an inch. For example, length A which is the greatest length between the perpendiculars parallel to the long axis of the skull, absent the lower jaw and excluding malformations; whereas width B is the greatest width measured between perpendiculars at right angles to the long axis; so if the skull length measures 13 inches length wise (length A), and measures 7 and 6/16 inches width wise (length B), then the score of the trophy, namely A plus B, would be 20 and 6/16. This scoring system is also used on the cougar and jaguar. In any case, this system is after the fact, namely, post mortem, and is much unlike the sport of fishing where there are throw backs.

FIGS. 2 and 3 exhibit the accepted method of scoring a typical whitetail and coues deer for the New York State Big Buck Club (NYS-big-buck.org), the Pope & Young Club, and the Boone & Crockett Club (boone-crockett.org), although each organization may vary regarding the acceptable minimum based on method of taking the animal, however, the methods of calculating appear constant. All measurements must be made with a quarter inch wide flexible steel tape to the nearest one-eighth (⅛ ) of an inch; wherein all fractional figures are in eighths without reduction (Note: a flexible steel cable can be used to measure points and main beams only).

Hence, it would be beneficial therefore to provide a hunting system and device, for at least all 33 North American big game as defined by Pope and Young for bow hunting and Boone and Crockett for firearm hunting, that harmonizes the laws of the land, with a hunter's desire for compliance therewith, in addition to a hunter's insatiable desire to conquer larger, potentially record setting game, whether it be the personal, state, national or international record, while minimizing the negative impact on the natural resources, environment, nature, and ecosystem. Lastly, this invention is not limited by the political boundaries, such as North America, but rather, what controls is the geographical locale of the game. More particularly, bears are found throughout the world, thus this technology may be used throughout the world as well.

### SUMMARY OF THE INVENTION

It is an advantage of the present invention to provide a hunting system comprising: a sighting means for aiming said system at a desired target and collecting input data regarding said desired target creating an actual profile, said means being cooperatively connected to a database means and a processing means, said database means having a historical profile of a target at various distances, and orientations; said processing means determines the nearest match between the two profiles, and displays the determination on an indicating means.

It is another advantage of the present invention to provide a hunting device comprising: a sighting means for aiming said device at a desired target and collecting input data regarding said desired target creating an actual profile, said means being cooperatively connected to a database means and a processing means, said database means having a historical profile of a target at various distances, and orientations; said processing means determines the nearest match between the two profiles, and displays the determination on an indicating means.

It is a further advantage of the invention to provide a novel system which is of relatively noncomplex construction, inexpensive to manufacture, and easy to use.

Lastly, other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIG. 1 is a score sheet for a bear;

FIG. 2 is a score sheet for a typical whitetail deer;

FIG. 3 exhibits the method of calculating the score for the respective game hereinabove;

FIG. 4 is block diagram of a preferred embodiment;

FIG. 5a exhibits a flowchart of a preferred embodiment of the present invention; and

FIG. 5b exhibits a flowchart, which is a continuation of FIG. 5a, of a preferred embodiment.

### DETAILED DESCRIPTION OF THE INVENTION

The following descriptions of the preferred embodiments are presented to illustrate the present invention and are not to be construed to limit the claims in any manner whatsoever.

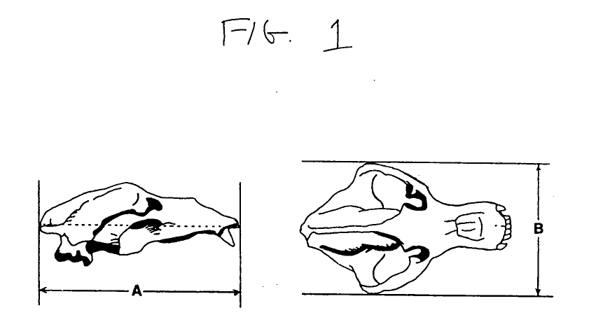

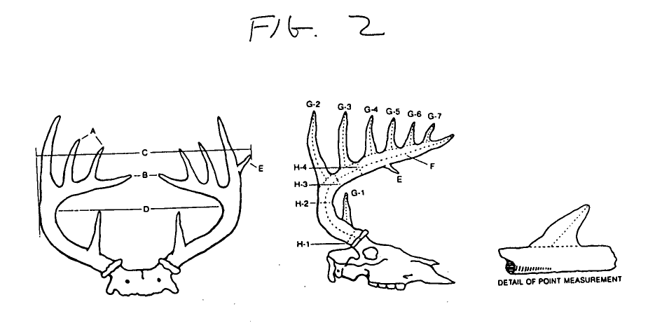

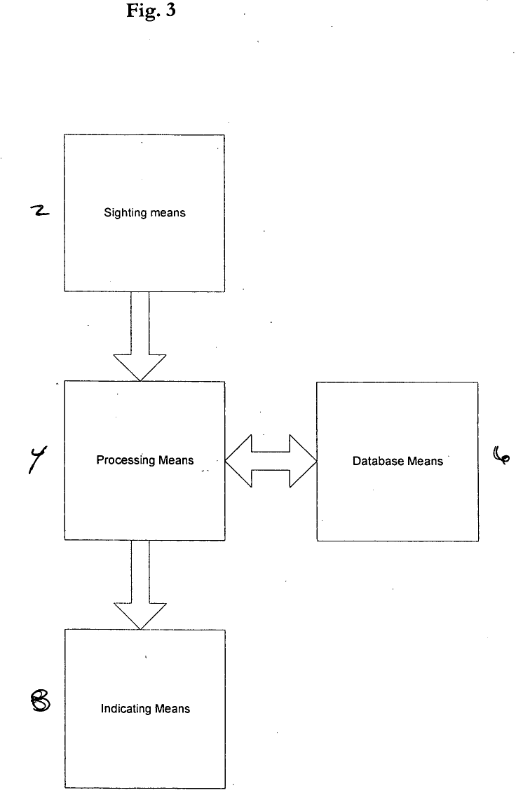

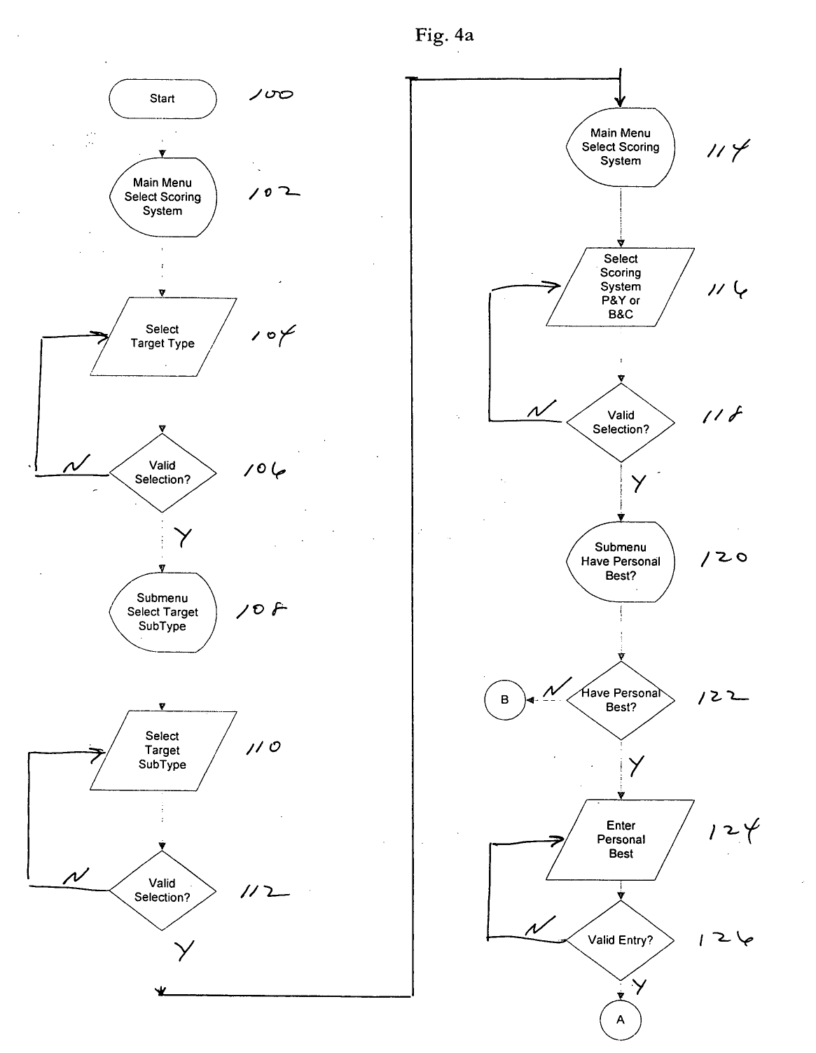

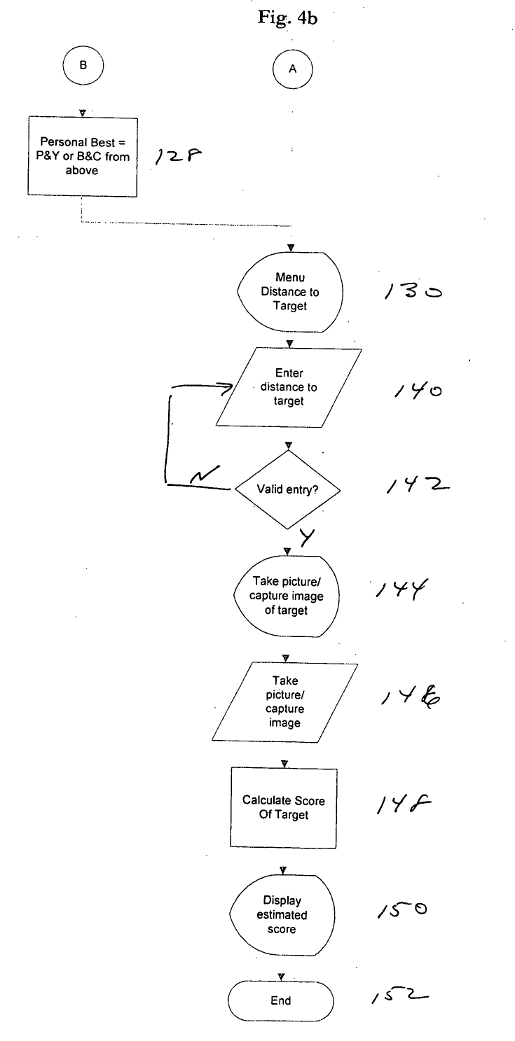

Referring now to the drawings wherein like reference numerals identify similar elements of the system set forth herein, is illustrated by FIGS. 1 through 5b, more particularly, FIGS. 4 through 5b.

FIG. 4 illustrates a block diagram of a preferred embodiment of the present invention, namely, sighting means 2 for viewing a desired target and capturing an image thereof, processing means 4 for calculating, database means 6 for storing data, and indicating means 8 for displaying information all cooperatively connected together which determines, inter alia, the estimated score of a desired target.

A preexisting database is established having a profile of each type of target, wherein a profile includes, inter alia, the following variables, target type, and optionally subtype, distance to the target, and overall length (hereafter OL) of the animal from nose to tail procured via the side view or top view of the animal. The profile optionally, may further include the following variables, the horizontal and vertical dimensions of the target, viewing angle such as 45 degree, target orientation such as standing or on all fours, weight, head/skull length, and width. It is this data that becomes the historical data from which the images are then compared.

FIGS. 5a and 5b illustrate a preferred embodiment, wherein the system begins at block 100 and proceeds to block 102, where a main menu is displayed, for example, on indicating means 8.

The system next proceeds to block 104, where the user selects from a menu, a desired target e.g., bear. At block 106, the system determines whether a valid menu choice was entered. If not, the system returns to block 104 for the user to enter a menu choice; if so, the system proceeds to block 108. At 108, the system displays a submenu of selectable subtypes, e.g., polar, black, brown, and the user selects a subtype at 110. It is envisioned that a sub-subtype may be incorporated, e.g., for brown bear, could have Kodiak and Grizzly.

At 112, the system determines whether a valid menu choice was entered. If not, the system returns to block 110 for the user to enter a menu choice; if so, the system proceeds to block 114.

At 114, the main menu, the option to select the type of scoring system is displayed, for example, Pope & Young, and Boone & Crocket. The system next proceeds to block 116 wherein the user selects a scoring system. At block 118, the system determines whether a valid menu choice was entered. If not, the system returns to block 116 for the user to select a menu choice; if so, the system proceeds to block 120, wherein a submenu is displayed exhibiting the option of a personal best score. At 122, the user enters whether or not he has a personal best; if so, then the user enters his score at 124, else, the user personal best is defaulted to a predetermined value, for example, zero, or in this example, the personal best is defaulted to the minimum score as defined by the scoring system at block 128 previously selected at block 116.

At block 126, the system determines whether a valid menu choice was entered. If not, the system returns to block 124 for the user to enter his personal best, else, the system proceeds to block 130 and prompts the user to enter the distance to the desired target from a menu. At block 140, the user enters the target distance. For example, if at block 116 the user selected Pope & Young, then the distance would be in feet, because bow hunting is at such a close range; although it is envisioned that this could also be in yards as is the Boone & Crockett (for firearms) distance menu display options.

At block 142, the system determines whether a valid menu choice was entered. If not, the system returns to block 140 for the user to enter the distance to desired target, else, the system proceeds to block 144. At block 144, the display prompts the user to capture an image, such as taking a picture of the desired target via sighting means 2, wherein the user takes the picture of the target preferably positioned from a side view or top view at block 146 to capture the (OL).

At block 148 the system calculates the estimated score of the desired target and displays such score at block 150 on indicating means 8. At block 152 the system ends.

For example, in another preferred embodiment, a target type, such as bear, or subtype, such as a black bear, distance such as 200 yards, viewing angle such as 45 degree side view, orientation such as walking on all fours (as compared to standing on the rear two feet or other position) may be inputted/selected by the user, i.e., manually.

In a preferred embodiment, for example, a menu system may be incorporated for the distance to the target, wherein the user may select the distance, or may, alternatively, manually enter the distance, or it is envisioned, that currently available distance technology may be incorporated with the device, for example, a range finder, incorporating laser technology therein. Since time is of the essence, it is envisioned that a menu system is more efficient than manually entering data, but a range finder is deemed optimal.

Wherein such inputted data will be compared to the historical preexisting database and substantially matched wherein the resulting profile, such as the weight of the target and/or most preferably, the corresponding skull size (aka score), which is thereafter be displayed on the indicating means 8, thereby enabling the user to make a more informed and reliable decision.

For example, it has been shown that there are skull size variations depending on type of bear, the bears diet, gender, and age, and within the unfleshed skull of the same bear depending on the season. See Leland P. Glenn, 1977 Morphometric Characteristics of Brown Bears on the Central Alaska Peninsula; Diet and Morphology of Extant and Recently Extinct Northern Bears; pp 313 to 330, Bear Biology Association Conference Series No. 3, Bears—Their Biology and Management—Papers of the Fourth Int'l Conference on Bear Research and Management. The zygomatic width of fleshed skulls averaged 93% of the live head width for males and 97% for females; skull length of fleshed skulls averaged 97% of the live head for both sexes, and the total skull size of fleshed skulls averaged 96% of the live head size for males and 97% for females for the brown bears sample in Alaska. As such, a preexisting database can be established incorporating such data, ratios, percentages, wherein the length of the skull appeared to be the strongest correlation between unfleshed and fleshed, here 97%. Similarly, a database can be established for the body length, height (shoulder), footprint, weight, gender, and correlations therebetween, as these measurements would be visual field measurements from an observer at a distance, whereas neck circumference, and girth would only be procurable by sedating or killing the animal which is not, at this time, useable information.

For example, New York State Department of Environmental Conservation Region 5 Wildlife unit provided data on black bear within New York State exhibited in Table 1a, and the Harvard Museum of Comparative Zoology for black bear and a polar bear shown herein below in Table 2a. Tables 1b, 2b, and 2c respectively, exhibit the proportional ratios between the head length (HL) and the overall length (OL) of the animal/target. As can be seen in Table 2b, the forecasted score of the bear is more accurate if the HL is known, as compared to Table 2c wherein the HL is unknown. Moreover, the average accuracy of where the HL is unknown is 1.18% difference between the actual score of the bear and the forecasted score, and having a standard deviation of 11.96%. Thus, based on this data sample, it is preferable to capture the HL and forecast the score from that dimension, although it may be forecast just capturing the OL.

TABLE 1a
NYSDEC

| | | | | | Left | | |
|---|---|---|---|---|---|---|---|
| | | Head | Overall | Neck | Shoul- | | |
| | Gen- | length | Length | Circum | der | Girth | Weight |
| Item | der | Inches | Inches | Inches | Inches | Inches | lbs |
| 1 | F | | | | | | 88 |
| 2 | M | 14.00 | 74.00 | 26.50 | 36.50 | 45.00 | 330 |
| 3 | F | 12.00 | 61.50 | 21.75 | 26.50 | 40.50 | 450 |
| 4 | M | 10.00 | 40.00 | 20.25 | 25.50 | 34.25 | 95 |
| 5 | F | 12.01 | 48.82 | | | 31.10 | 75 |
| 6 | M | 15.00 | 73.00 | 30.00 | 29.00 | 52.00 | 500 |
| 7 | M | 14.00 | 72.00 | 28.00 | 33.00 | 47.00 | 325 |
| Average | | 12.83 | 61.55 | 25.30 | 30.10 | 41.64 | 295.83 |
| Max | | 15.00 | 74.00 | 30.00 | 36.50 | 52.00 | 500.00 |
| Min | | 10.00 | 40.00 | 20.25 | 25.50 | 31.10 | 75.00 |
| STDEV | | 1.83 | 14.30 | 4.15 | 4.60 | 7.93 | 179.63 |

TABLE 1b

| | | Head | Overall | |
|---|---|---|---|---|
| | | length | Length | HL to |
| Item | Gender | Inches | Inches | OL |
| 1 | F | | | |
| 2 | M | 14.00 | 74.00 | 18.92% |
| 3 | F | 12.00 | 61.50 | 19.51% |
| 4 | M | 10.00 | 40.00 | 25.00% |
| 5 | F | 12.01 | 48.82 | 24.60% |
| 6 | M | 15.00 | 73.00 | 20.55% |
| 7 | M | 14.00 | 72.00 | 19.44% |
| Average | | 12.83 | 61.55 | 21.34% |
| Max | | 15.00 | 74.00 | 25.00% |
| Min | | 10.00 | 40.00 | 18.92% |
| STDEV | | 1.83 | 14.30 | 2.74% |

TABLE 2a
Harvard Museum of Comparative Zoology

| Bear | | | Length (mm) | | | | | Skull (mm) | | Weight |
|---|---|---|---|---|---|---|---|---|---|---|
| Id No. | Type | Gender | Overall | tail | hind foot | ear | shoulder | length | width | kg |
| MCZ | black | F | 1420 | 80 | 210 | 105 | 670 | 222 | 120 | 198 |
| 61104 | | | | | | | | | | |
| MCZ | black | M | 1465 | 80 | 249 | 133 | 820 | 265 | 150 | 71 |
| 62161 | | | | | | | | | | |
| MCZ | black | M | 1330 | 92 | 242 | 122 | | 260 | 148 | 60 |
| 61417 | | | | | | | | | | |
| MCZ | black | M | 1730 | 89 | 211 | 114 | 1090 | 292 | 188 | 145.5 |
| 63316 | | | | | | | | | | |
| MCZ | black | M | 1770 | 115 | 200 | 130 | | 285 | 163 | |
| 62920 | | | | | | | | | | |
| MCZ | polar | M | 1910 | 160 | 300 | 115 | 1130 | 400 | 235 | 231 |
| 62970 | | | | | | | | | | |
| Average | | | 1604.17 | 102.67 | 235.33 | 119.83 | 927.50 | 287.33 | 167.33 | 141.10 |
| Max | | | 1910.00 | 160.00 | 300.00 | 133.00 | 1130.00 | 400.00 | 235.00 | 231.00 |
| Min | | | 1330.00 | 80.00 | 200.00 | 105.00 | 670.00 | 222.00 | 120.00 | 60.00 |
| STDEV | | | 230.36 | 30.88 | 37.14 | 10.57 | 220.06 | 60.39 | 39.85 | 75.55 |

TABLE 2b

| Bear | HL to | HW to | HW | Score (HL known) | | |
|---|---|---|---|---|---|---|
| Id. No. | OL | OL | TO HL | Actual | Forecast | % diff |
| MCZ | 15.63% | 8.45% | 54.05% | 13.46 | 13.81 | 2.55% |
| 61104 | | | | | | |
| MCZ | 18.09% | 10.24% | 56.60% | 16.34 | 16.48 | 0.88% |
| 62161 | | | | | | |
| MCZ | 19.55% | 11.13% | 56.92% | 16.06 | 16.17 | 0.67% |
| 61417 | | | | | | |
| MCZ | 16.88% | 10.87% | 64.38% | 18.90 | 18.16 | −3.90% |
| 63316 | | | | | | |
| MCZ | 16.10% | 9.21% | 57.19% | 17.64 | 17.73 | 0.50% |
| 62920 | | | | | | |
| MCZ | 20.94% | 12.30% | 58.75% | 25.00 | 24.88 | −0.49% |
| 62970 | | | | | | |
| Average | 17.87% | 10.37% | 57.98% | 17.90 | 17.87 | 0.04% |
| Max | 20.94% | 12.30% | 64.38% | 25.00 | 24.88 | 2.55% |
| Min | 15.63% | 8.45% | 54.05% | 13.46 | 13.81 | −3.90% |
| STDEV | 2.07% | 1.39% | 3.48% | 3.58 | 3.76 | 2.16% |

TABLE 2c

| Bear | HL to | HW to | HW | Score (OL known) | | |
|---|---|---|---|---|---|---|
| Id. No. | OL | OL | TO HL | Actual | Forecast | % diff |
| MCZ | 15.63% | 8.45% | 54.05% | 13.46 | 15.78 | 17.22% |
| 61104 | | | | | | |
| MCZ | 18.09% | 10.24% | 56.60% | 16.34 | 16.28 | −0.34% |
| 62161 | | | | | | |
| MCZ | 19.55% | 11.13% | 56.92% | 16.06 | 14.78 | −7.97% |
| 61417 | | | | | | |
| MCZ | 16.88% | 10.87% | 64.38% | 18.90 | 19.23 | 1.75% |
| 63316 | | | | | | |
| MCZ | 16.10% | 9.21% | 57.19% | 17.64 | 19.67 | 11.54% |
| 62920 | | | | | | |
| MCZ | 20.94% | 12.30% | 58.75% | 25.00 | 21.23 | −15.08% |
| 62970 | | | | | | |
| Average | 17.87% | 10.37% | 57.98% | 17.90 | 17.83 | 1.18% |
| Max | 20.94% | 12.30% | 64.38% | 25.00 | 21.23 | 17.22% |
| Min | 15.63% | 8.45% | 54.05% | 13.46 | 14.78 | −15.08% |
| STDEV | 2.07% | 1.39% | 3.48% | 3.58 | 2.56 | 11.96% |

Furthermore, it has been shown that the relationship between body length and pad width, and skull width and pad width were essentially linear as the power coefficients were close to one, thus body length and skull width increased at a constant rate with increasing pad width with a confidence level of 95%. See Robert T. Brooks et al. 1998, Predictive Relationships Between Age And Size And Front Foot Pad Width Of Northeastern Minnesota Black Bears, Ursus Americanus, in the Canadian Field Naturalists 112(1): 82-85, which is incorporated by reference herein.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application.

What is claimed is:

1. A hunting system comprising:
sighting means for aiming said system at a desired target and collecting input data regarding said desired target creating an actual profile, said means being cooperatively connected to database means, processing means, and indicating means, said database means for storing a historical profile of a target at various distances,
said processing means for determining the nearest match between the two profiles, and said indicating means for displaying the determination.

2. A hunting system as in claim 1, wherein said sighting means includes collecting an image of a desired target.

3. A hunting system as in claim 1, wherein said sighting means includes means for manually entering data.

4. A hunting system as in claim 1, wherein said database means includes a plurality of profiles.

5. A hunting system as in claim 1, wherein a target profile includes one or more of the following variables, target type, distance, horizontal, vertical, weight, head length, and head width; wherein the target type, and the distance between the user and the desired target, is inputted by the user; wherein the horizontal and vertical dimensions shall be matched via said processor and displayed via said indicating means.

6. A hunting system as in claim 1, wherein said indicating means includes a trigger sure means cooperatively connected to a firearm trigger system.

7. A hunting system as in claim 6, wherein said trigger sure means includes a feature wherein a firearm trigger system may not be activated if the results fail to meet user defined inputted criteria.

8. A hunting system as in claim 1, wherein said output includes the estimated score of the desired target.

9. A hunting system as in claim 1, wherein said output includes the estimated weight of the desired target.

10. A hunting system as in claim 1, wherein entering of data includes a selectable menu system.

11. A hunting device comprising:
sighting means for aiming said device at a desired target and collecting input data regarding said desired target creating an actual profile, said means being cooperatively connected to database means, processing means, and indicating means; said database means for storing historical profile of a target at various distances, and orientations; said processing means for determining the nearest match between the two profiles, said indicating means for displaying the determination thereon.

12. A hunting device as in claim 11, wherein said sighting means includes collecting an image of a desired target.

13. A hunting device as in claim 11, wherein said sighting means includes means for manually entering data.

14. A hunting device as in claim 11, wherein said database means includes a plurality of profiles.

15. A hunting device as in claim 11, wherein a target profile includes the following variables, target type, distance, horizontal, vertical, weight, head length, and head width; wherein the target type, and the distance between the user and the desired target is inputted by the user; wherein the selected criteria shall be matched by said processing means and displayed accordingly.

16. A hunting device as in claim 11, wherein said indicating means includes a trigger sure means cooperatively connected to a firearm trigger device.

17. A hunting device as in claim 16, wherein said trigger sure means includes a feature wherein a firearm trigger device may not be activated if the results fail to meet user defined inputted criteria.

18. A hunting device as in claim 11, wherein said output includes the estimated weight of the desired target.

19. A hunting system as in claim 11, wherein said output includes the score of the desired target.
